(19) United States
(12) Patent Application Publication
(10) Pub. No.: US 2015/0372719 A1
(43) Pub. Date: Dec. 24, 2015

(54) BUSINESS CONTACT INFORMATION EXCHANGING APPARATUS AND METHOD

(71) Applicant: Thaddeus Stephen Greene, Westbrook, MA (US)

(72) Inventor: Thaddeus Stephen Greene, Westbrook, MA (US)

(21) Appl. No.: 14/309,525

(22) Filed: Jun. 19, 2014

(51) Int. Cl. H04B 5/00; H04W 4/00

(52) U.S. Cl. CPC H04B 5/0031; H04W 4/008

(57) ABSTRACT

A plaque including an embedded near field communication (NFC) chip is provided. The plaque may be formed to rest on a user's desk. The NFC chip includes information such as the user's name, business address, email address, phone number and the like. A customer may tap their smart device on the plaque to receive information that is typically on a business card.

### BACKGROUND OF THE INVENTION

The present invention relates to a business information exchange and, more particularly, to a plaque including a wireless data exchange unit with business contact information.

Business cards are cards bearing business information about a company or individual. They are shared during formal introductions as a convenience and a memory aid. A business card typically includes the giver's name, company or business affiliation (usually with a logo) and contact information such as street addresses, telephone number(s), fax numbers, e-mail addresses and website. Business cards may be distributed at business events and may be distributed in a professional's office. In the ever increasing paperless world, the electronic business card has increased in popularity. However, currently there is no device that produces an electronic business card on a desk at a professional's office.

As can be seen, there is a need for a device that may be placed on a professional's desk to distribute an electronic business card.

### SUMMARY OF THE INVENTION

In one aspect of the present invention, a method of exchanging business card information comprises: providing a plaque comprising: a body; and a wireless data exchange unit attached to the body, wherein the wireless data exchange unit comprises data comprising business card information comprising at least a name and a business contact information; and placing the plaque on a desk, wherein the desk is located at a place of business.

In another aspect of the present invention, a business information exchanging apparatus comprises: a plaque comprising a bottom surface, wherein the bottom surface is configured to support the plaque in an upright position on a desk; and a wireless data exchange unit embedded within the plague, wherein the wireless data exchange unit comprises data comprising at least a name and a business contact information

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a section view of the present invention along line 2-2 in FIG. 1;

FIG. 3 is a bottom perspective view of the present invention;

FIG. 4 is a side view of the present invention; and

FIG. 5 is a front view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a plaque that is formed to rest on a user's desk. The plaque includes an embedded near field communication chip that includes information, such as the user's name, business address, email address, phone number and the like. A customer may tap their smart device on the plaque to receive information that is typically on a business card.

The present invention includes a near field communication (NFC) chip embedded in plaque, such as a piece of wood or plastic. The NFC chip may transfer data such as the user's business contact information. The plaque of the present invention may further include custom engraving, and may be carved into any ornamental shape or design. The engraving may include instructions on how to use the present invention, as well as the information within the NFC chip. The user may simply place the present invention on a desk with the engraving instructions, and a third party may tap their phone and receive the contact information of the user.

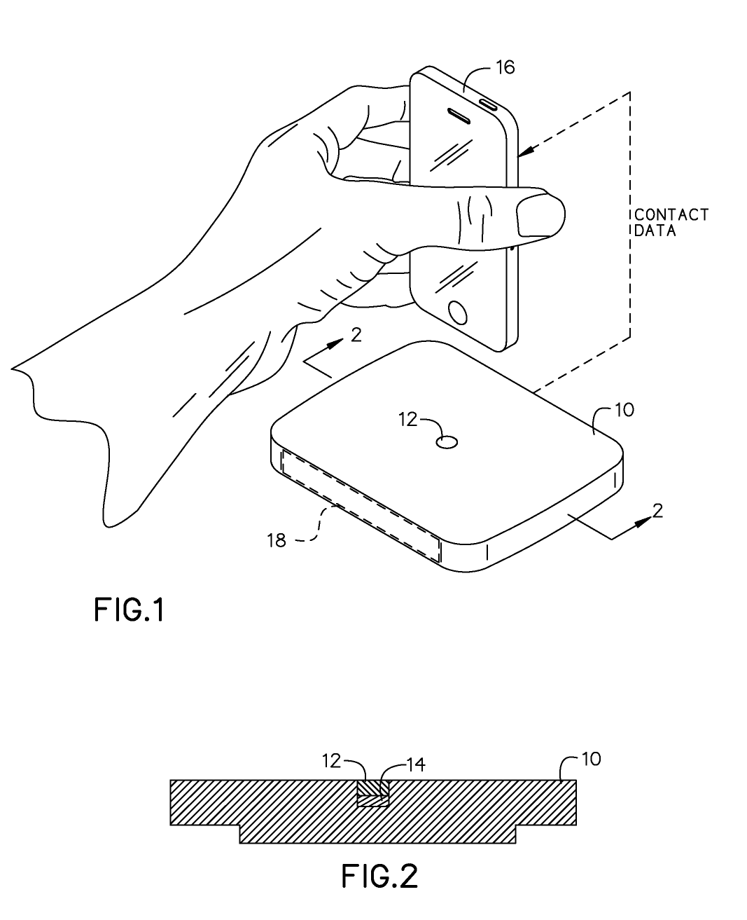

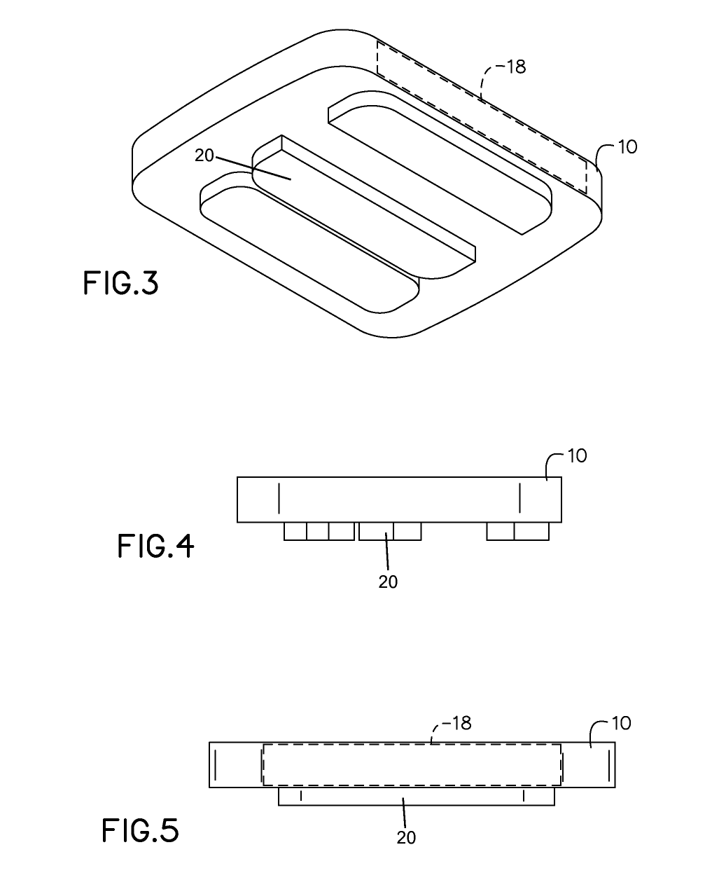

Referring to FIGS. 1 through 5, the present invention includes a business information exchanging apparatus in the form of a plaque 10. The plaque 10 includes a body having a bottom surface that is formed to support the plaque 10 in an upright position when placed on a desk or other surface. The present invention may further include a wireless data exchange unit 14 embedded within the plague 10.

The wireless data exchange unit 14 may include data having at least a name and business contact information. Therefore, a user with a smart device 16, such as a phone or tablet, may be able to tap their smart device 16 on the plaque 10 and receive the business information. The business contact information may include a business phone number, a business fax number, a business e-mail address, a business website, and/or a business address.

In certain embodiments, the wireless data exchange unit 14 is a near field communication (NFC) chip. The wireless data exchange unit 14, such as the NFC chip, may fit within a recess formed in the plaque 10. A filler 12 may be placed within the recess, so that the NFC chip is sandwiched in between the plaque 10 and the filler 12.

The plaque 10 of the present invention may be made of at least one of wood, glass, and plastic. The plaque 10 may be carved into a design or shape of the user's choice. In certain embodiments, the plaque 10 may include an engraving 18 disposed on an outside surface of the plaque 10. The engraving 18 may include instructions on how to use the plaque 10 and other information, such as the business information stored on the NFC chip.

The present invention may include a stand 20 disposed on the bottom surface of the plaque 10. The stand 20 is configured to support the plaque 10 in an upright position on the desk. In certain embodiments, the plaque 10 may be shaped as a card holder, and hold physical business cards, while providing the information electronically, giving the third party a choice.

A method of exchanging business card information may include the following. The plaque 10 mentioned above may be placed on a desk. The desk may be located at a place of business. A third party, such as a customer, may take their smart device 16 and tap the plaque 10. The data may exchange from the wireless data exchange unit 14, such as the NFC chip, to the customer's smart device 16. The data, including the name and business information of the user, may be stored on the customer's smart device and may be used at a later time.

A method of making the present invention may include the following. A piece of wood, plastic, or glass may be customized to a desired shape or design to create the plaque 10. An NFC chip may be embedded into a recess on the plaque. The recess may be filled with wood, glass or plastic. The wood, plastic or glass may be painted, stained, polished, and/or finished. The business contact information may be programmed within the NFC chip. The plaque 10 acts as the fixture and as the appeal. The NFC chip acts as the medium to store the information and transmit the information.

It should be understood, of course, that the foregoing relates to exemplary embodiments of the invention and that modifications may be made without departing from the spirit and scope of the invention as set forth in the following claims.

What is claimed is:

1. A method of exchanging business card information comprising:
providing a plaque comprising:
a body; and
a wireless data exchange unit attached to the body,
wherein the wireless data exchange unit comprises data comprising business card information comprising at least a name and a business contact information;
placing the plaque on a desk, wherein the desk is located at a place of business.

2. The method of claim 1, wherein the wireless data exchange unit is a near field communication chip.

3. The method of claim 2, wherein the near field communication chip is embedded within the plaque.

4. The method of claim 1, further comprising the step of placing a smart device near the plaque, wherein the smart device receives the data.

5. The method of claim 1, wherein the plaque is made of at least one of wood, glass, and plastic.

6. The method of claim 1, wherein the plaque comprises an engraving.

7. The method of claim 1, wherein the plaque comprises a bottom surface comprising a stand, wherein the stand is configured to support the plaque in an upright position on the desk.

8. The method of claim 1, wherein the business contact information comprises at least one of a phone number, an e-mail address, a business website, a business fax number, and an address.

9. A business information exchanging apparatus comprising:
a plaque comprising a bottom surface, wherein the bottom surface is configured to support the plaque in an upright position on a desk; and
a wireless data exchange unit embedded within the plague, wherein the wireless data exchange unit comprises data comprising at least a name and a business contact information

10. The business information exchanging apparatus of claim 9, wherein the wireless data exchange unit is a near field communication chip.

11. The business information exchanging apparatus of claim 9, wherein the near field communication chip is within a recess formed in the plaque.

12. The business information exchanging apparatus of claim 11, further comprising a filler within the recess, wherein the near filed communication chip is sandwiched in between the plaque and the filler.

13. The business information exchanging apparatus of claim 9, wherein the plaque is made of at least one of wood, glass, and plastic.

14. The business information exchanging apparatus of claim 9, further comprising an engraving disposed on an outside surface of the plaque.

15. The business information exchanging apparatus of claim 9, further comprising a stand disposed on the bottom surface, wherein the stand is configured to support the plaque in an upright position on the desk.

16. The business information exchanging apparatus of claim 1, wherein the business contact information comprises at least one of a business phone number, a business e-mail address, a business website, a business fax number, and a business address.
